(19) United States
(12) Patent Application Publication
(10) Pub. No.: US 2022/0411000 A1
(43) Pub. Date: Dec. 29, 2022

(54) PERCH MOUNT HANDGUARD

(71) Applicant: TAILAI TING, POMONA, CA (US)

(72) Inventor: TAILAI TING, POMONA, CA (US)

(21) Appl. No.: 17/362,801

(22) Filed: Jun. 29, 2021

(51) Int. Cl. B62J 23/00; B62K 21/12

(52) U.S. Cl. CPC B62J 23/00; B62K 21/12

(57) ABSTRACT

A handguard assembly for handlebars is provided. In one embodiment, the handguard mounting assembly includes a pair of arm members, a pair of modified perches, a pair of adapters, and a pair of mounting devices. In this embodiment, the modified perches are used to install the handguard. Each arm member is configured to connect to one of the pair of mounting devices through the modified perch and is further configured to connect to an end portion of a respective handlebar. The adapters are used to connect the modified perch and mounting hardware when the perches are installed in front and back direction. The adapters are not needed when the perches are installed in up and down direction.

### FIELD OF INVENTION

The present invention relates to a handguard for a handlebar. In particular, the present application relates to a perch mount handguard for a handlebar of a vehicle, such as a motorbike, motorcycle, motor scooter, ATV, bicycle or tricycle.

### BACKGROUND

Handguards for protecting the hands of riders of motorbikes, motorcycles, motor scooters, ATVs, bicycles and tricycles are known in the art. The handguard is configured to protect a rider's hands from wind, rain, and debris. In one known embodiment, two separate handguards are configured to be mounted on a pair of handlebars. A left handguard usually includes a left arm member, and a mounting member, and is mounted to a left handlebar. A right handguard usually includes a right arm member, and a mounting member, and is mounted to a right handlebar. The left and right handguards can be connected or disconnected to outer portions of the handlebars.

Currently on the market, most handguards are individually mounted to handlebars with additional mounting hardware. The additional mounting hardware would take up the limited space on handlebars. Also, such handguards with additional mounting hardware will affect the flexibility of the operation on brake and clutch levers. For example, in professional dirt bike races, riders would untight the mounting hardware of handguards to make it easier to when pressing brake and clutch levers. What might also cause a problem is that the additional mounting hardware comes with the handguard usually come with one or two size which would not be universally compatible with all handlebars of different brands on the market.

### SUMMARY OF THE PRESENT INVENTION

A main object of the present invention is to provide a perch mount handguard, wherein the user can install it with a modified perch piece as a replacement of the original perch.

Another advantage of the present invention is to provide a perch mount handguard, wherein the user can install with a modified perch piece to make the handguard shorter in length, and therefore, it is stronger in strength.

Another advantage of the invention is to provide a perch mount handguard, wherein the user can install with a modified perch piece to free up the limited space on handlebars.

Another advantage of the invention is to provide a perch mount handguard, wherein the user can install the handguard on a modified perch piece with a pair of adapters to avoid fitment issue.

### BRIEF DESCRIPTION OF THE DRAWINGS

FIG. 1 is a perspective view of a perch mount handguard assembly in the preferred embodiment of the present invention.

FIG. 2 is a perspective view of a pair of modified perches in the preferred embodiment of the present invention.

FIG. 3 is a perspective view of a pair of mounting hardware devices in the preferred embodiment of the present invention.

FIG. 4 is a perspective view of a pair of arm members in the preferred embodiment of the present invention.

FIG. 5 is a perspective view of a pair of modified perches, a pair of mounting hardware devices and a pair of arm members in the preferred embodiment of the present invention.

FIG. 6 is a perspective view of a pair of modified perches, a pair of mounting hardware devices, a pair of arm members and a pair of adapters in an alternative embodiment of the present invention.

### DETAILED DESCRIPTION OF THE INVENTION

The following description is disclosed to enable any person skilled in the art to make and use the present invention. Preferred embodiments are provided in the following description only as examples and modifications will be apparent to those skilled in the art. The general principles defined in the following description in the following description would be applied to other embodiments, alternatives, modifications, equivalents, and applications without departing from the spirit and scope of the present invention.

The following description is directed to a perch mount handguard for a handlebar of a vehicle, such as a motorbike, motorcycle, motor scooter, ATV, bicycle or tricycle. The handguard may be employed to protect a rider's hand from wind, rain, and debris.

“Right” and “left” as used herein refer to the right and left directions as viewed from the perspective of a rider of the vehicle.

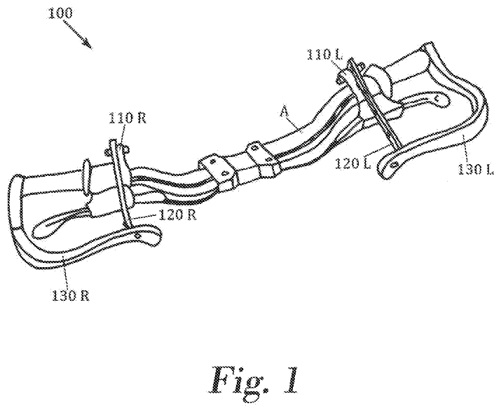

FIG. 1 illustrates a perspective view of one embodiment of a perch mount handguard assembly 100, including right and left modified perches 110 L, R, mounted on a handlebar A of a vehicle, right and left mounting hardware devices 120 L, R, mounted on the modified perches 110 L, R, and right and left arm members 130 L, R, mounted on mounting hardware devices 120 L, R.

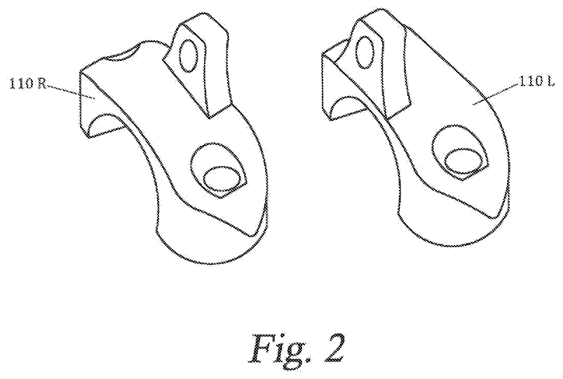

FIG. 2 illustrates a perspective view of a pair of modified perches 110 L, R, of one embodiment of the present invention, showing how the shape of the perches are modified to include a screw hole on the top.

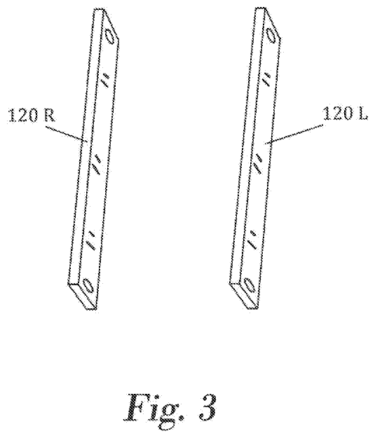

FIG. 3 illustrates a perspective view of a pair of mounting hardware devices 120 L, R, of one embodiment of the present invention, showing how the mounting hardware devices were used to connect the perches 110 L, R and the arm members of the handguards 130 L, R.

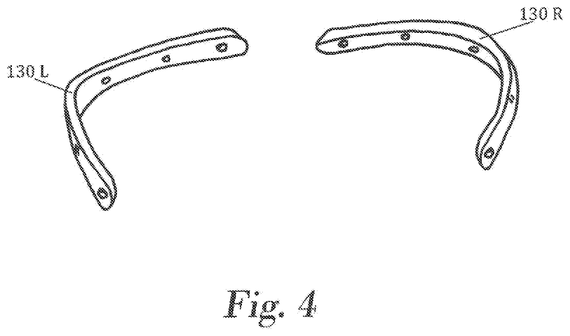

FIG. 4 illustrates a perspective view of a pair of arm members 130 L, R, of one embodiment of the present invention, showing how the arm members are connected to the mounting hardware devices 120 L, R on one end and how the other end of the arm members are connected to the end side of handlebars of vehicles.

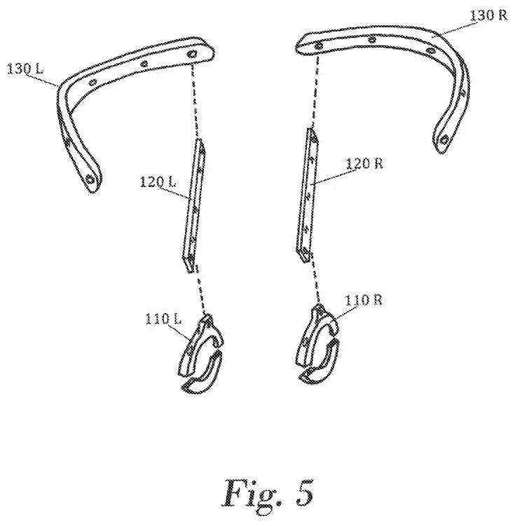

FIG. 5 illustrates a perspective view of a pair of modified perches 110 L, R, a pair of mounting hardware devices 120 L, R, and a pair of arm members 130 L, R, in the preferred embodiment of the present invention, showing how one embodiments of a perch mount handguards are installed on the handlebar when the perches are secured in an up and down vertical position on the handlebar.

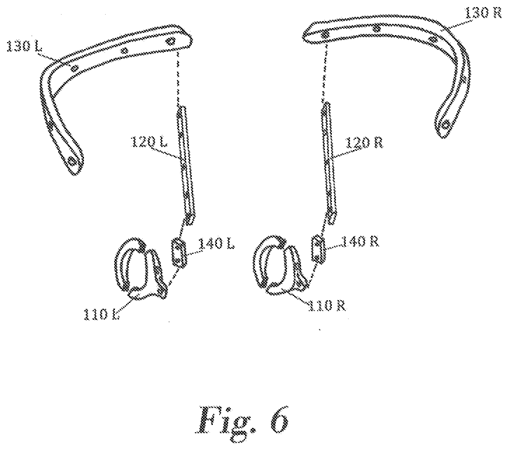

FIG. 6 is a perspective view of a pair of modified perches 110 L, R, a pair of mounting hardware devices 120 L, R, a pair of arm members 130 L, R, and a pair of adapters 140 L, R, in an alternative embodiment of the present invention, showing how one embodiments of a perch mount handguards are installed on the handlebar with attaching a pair of adapters on the modified perches to the mounting hardware devices when the perches are secured in a front and back horizontal position.

1. A handguard assembly for a pair of handlebars, the handguard assembly comprising:
a pair of modified perches; and
a pair of mounting devices; and
a pair of arm members; and configured to connect to one of the pair of mounting devices through the modified perch and is further configured to connect to an end portion of a respective handlebar; and
a pair of adapters.

2. The handguard assembly of claim 1, wherein the pair of perches are modified to include screw holes on top to enable installation of handguards onto the perches directly.

3. The handguard assembly of claim 1, wherein the pair of mounting devices are configured to connect the handguards to the modified perches.

4. The handguard assembly of claim 1, wherein the pair of arm members are configured to connect to one of the pair of mounting devices through the modified perch and is further configured to connect to an end portion of a respective handlebar.

5. The handguard assembly of claim 1, wherein the pair of adapters are used to connect the modified perch and mounting hardware when the perches are installed in front and back direction. The adapters are not needed when the perches are installed in up and down direction.

6. The handguard assembly of claim 1, wherein the handguard is mounted where the perches are located, which makes the arms of handguards shorter in length, and therefore, stronger in strength.

7. The handguard assembly of claim 6, wherein the handguards are mounted where the perches are located, which saves the space of additional handguard mounting hardware and free up the limited space of handlebar.

8. The handguard assembly of claim 5, wherein the pair of adapters makes the design universally fit to handlebars of different brands on the market.
